(19) United States
(12) Patent Application Publication
(10) Pub. No.: US 2007/0130513 A1
(43) Pub. Date: Jun. 7, 2007

(54) Printing device with an embedded extensible stylesheet language transform and formatting functionality

(75) Inventors: Judith A. Slein, Rochester, NY (US); Neil R. Sembower, Webster, NY (US); Barry G. Gombert, Rochester, NY (US)

Correspondence Address: BASCH & NICKERSON LLP, 1777 PENFIELD ROAD, PENFIELD, NY, 14526, US

(73) Assignee: Xerox Corporation, Stamford, CT (US)

(21) Appl. No.: 11/294,212

(22) Filed: Dec. 5, 2005

(51) Int. Cl. G06F 15/00

(52) U.S. Cl. 715/523

(57) ABSTRACT

A digital printing device accepts text input with embedded metadata. The metadata is translated into print format instructions. The actual translation of the metadata into print format instructions is done with reference to an extensible stylesheet language transform (and, optionally, an extensible markup language schema) that may be retrieved from the network, stored in the memory of the digital printing device, or read from the input data stream.

### BACKGROUND

Encoding documents for digital printing is conventionally done in a document or image processing device that is typically separate from the printing device. The processing device may be a personal computer or other document/image processing/generation device. The processing device, typically, has a generic print driver application that encodes and sends documents for reproduction by a particular printer connected thereto, through a communication channel or network.

The generation of standard document types is a growing trend. Such standards have been greatly encouraged and facilitated by the use of the standard extensible markup language. However, the reproduction of standard extensible markup language is not an easy task as the standard extensible markup language has been, conventionally, converted by the user into some type of format that is readily acceptable to a printing device.

Thus, it is desirable to have a printing device that can receive a document in such a standard format directly without the need of user intervention. Moreover, it is desirable to have a printing device that is capable of accepting extensible markup language and using the extensible markup language to produce a printed document, the document being particularly specified in the extensible markup language.

### BRIEF DESCRIPTION OF THE DRAWINGS

The drawings are only for purposes of illustrating an embodiment and is not to be construed as limiting, wherein:

FIG. 1 illustrates a conventional printing device;

FIG. 2 illustrates the architecture of a conventional printing device;

FIG. 3 illustrates the architecture of a printing device with an embedded extensible markup language processor;

FIG. 4 illustrates a block diagram of an embedded extensible markup language processor; and

FIG. 5 illustrates a block diagram of another example of an embedded extensible markup language processor.

### DETAILED DESCRIPTION

For a general understanding, reference is made to the drawings. In the drawings, like references have been used throughout to designate identical or equivalent elements. It is also noted that the drawings may not have been drawn to scale and that certain regions have been purposely drawn disproportionately so that the features and concepts could be properly illustrated.

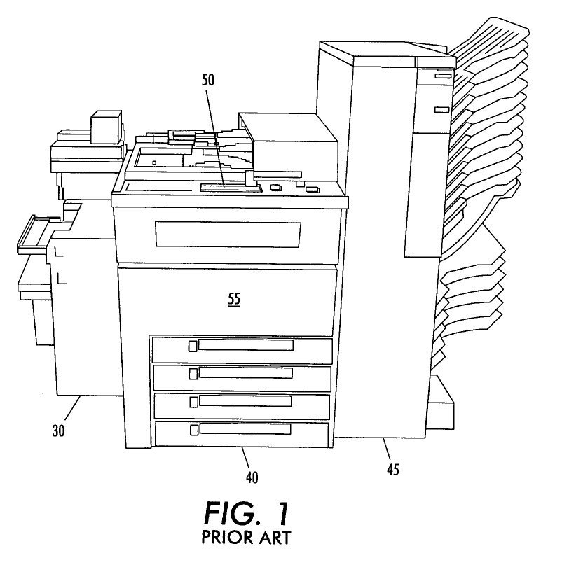

FIG. 1 illustrates an overall construction of a digital printing device unit. The digital printing device, as illustrated in FIG. 1, includes a print engine 55 within the housing of the digital printing device. The digital printing device also includes a user interface 50 and a communication interface (not shown) to provide communication between the digital printing device and remote devices.

The digital printing device may also include a finisher device 45; e.g., a sorter, mailboxes, stapler, etc.; and a plurality of recording medium trays 40 that store the paper used in the printing process. Lastly, the digital printing device may include a high capacity feeder 30 that is capable of holding large amounts of recording medium to be used by the digital printing device.

With respect to the printing, the print engine 55 retrieves the proper recording medium from one of the multiple trays 40 or the high capacity feeder 30, render the desired image on the retrieved recording medium, and output the printed image to the finishing device 45 for further operations. The user interface 50 allows the user to control the various functions of the digital printing device by providing the user an opportunity to program certain job characteristics or functions.

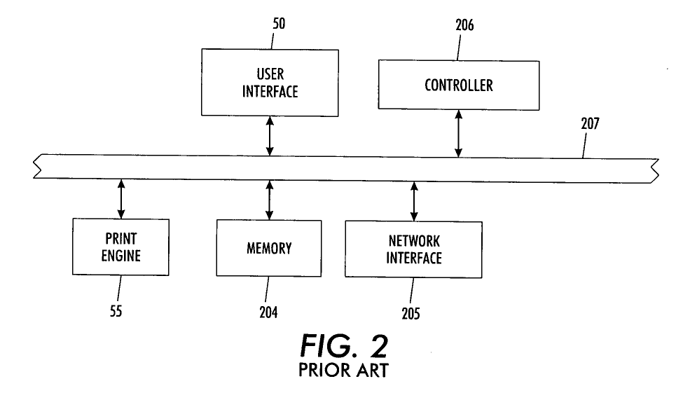

As noted above, FIG. 2 illustrates the architecture of a conventional printing device. The architecture, as illustrated in FIG. 2, includes a print engine 55, a user interface 50, a memory 204, a network interface 205, a controller 206, and a bus 207.

The print engine 55 converts digital signals representing an image into a hardcopy of that image on a recording medium. A central bus 207 provides interconnections and intercommunications between the various modules and devices connected thereto. A memory 204 store a variety of information such as machine fault information, machine history information, images to be processed at a later time, instruction sets for the machine, job instruction sets, etc.

The user interface 50 allows the user to select the various functions of the digital printing device, program various job attributes for the particularly selected function, provide other input to the digital printing device, as well as, display informational data from the digital printing device. The controller 206 controls all the functions within the digital printing device so as to coordinate all the interactions between the various modules and devices.

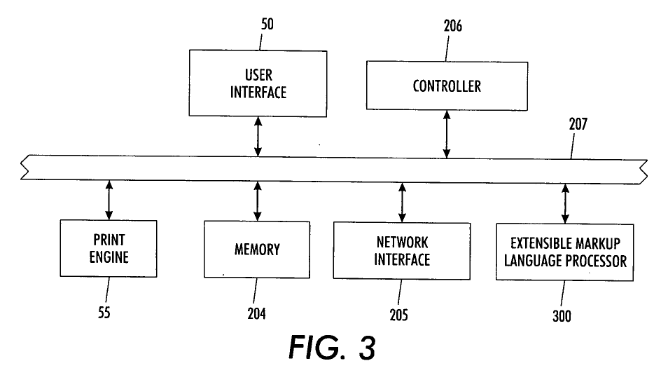

As noted above, it is desirable to provide a digital printing device with the functionality to directly process extensible markup language. FIG. 3 illustrates the architecture of a digital printing device capable of directly processing extensible markup language.

As illustrated in FIG. 3, the architecture includes a print engine 55, a user interface 50, a memory 204, a network interface 205, a controller 206, an extensible markup language processor 300, and a bus 207.

The print engine 55 converts digital signals representing an image into a hardcopy of that image on a recording medium. A central bus 207 provides interconnections and intercommunications between the various modules and devices connected thereto. A memory 204 store a variety of information such as machine fault information, machine history information, images to be processed at a later time, instruction sets for the machine, job instruction sets, etc.

The user interface 50 allows the user to select the various functions of the digital printing device, program various job attributes for the particularly selected function, provide other input to the digital printing device, as well as, display informational data from the digital printing device. The controller 206 controls all the functions within the digital printing device so as to coordinate all the interactions between the various modules and devices.

The extensible markup language processor 300 receives extensible markup language data and converts this data into a page description language which can readily utilized by the controller 206 and print engine 55 to generate the appropriate document or image. The details of this process will be explained in more detail below.

The following descriptions will useful in understanding the operations of the extensible markup language processor.

Extensible markup language is a conventional standards-based way of organizing data and metadata in the same document. More specifically, extensible markup language is not a fixed format, but rather a meta language that enables the design of customized markup languages for different types of documents. Extensible markup language is a markup language because every structural element is marked by a start tag and an end tag giving the name of the element. In other words, the metadata of the extensible markup language is enclosed within tags. With respect to the input stream of the document, a tag may be delimited by the symbols “<” and “>”. In one implementation, extensible markup language can be used as the format for receiving input data and metadata.

An extensible markup language vocabulary is a collection of extensible markup language tags (element and attribute names) intended to be used together as a single markup language. An extensible stylesheet language transform is a set of rules for transforming a source extensible markup language document into a result extensible markup language document, using the syntax defined in extensible stylesheet language transformations. Extensible stylesheet language transformations are often used to insert styling instructions into an extensible markup language document or to convert the extensible markup language document into an extensible markup language vocabulary designed for formatting.

An extensible stylesheet language transform imparts style to the data and can also be a general tree transformation language. Moreover, an extensible markup language schema is the formal definition of an extensible markup language vocabulary.

An extensible stylesheet language transform is a way of expressing a mapping of metadata tags and print format instructions.

Since an extensible stylesheet language transform and an extensible markup language schema are text based documents, the extensible stylesheet language transform and extensible markup language schema can be easily stored in a memory. Although extensible stylesheet language transforms can be written that work well in the absence of an extensible markup language schema, more expressive mappings can be written in an extensible stylesheet language transform if an extensible markup language schema for the input document is supplied.

The extensible stylesheet language is an extensible markup language vocabulary for specifying formatting semantics.

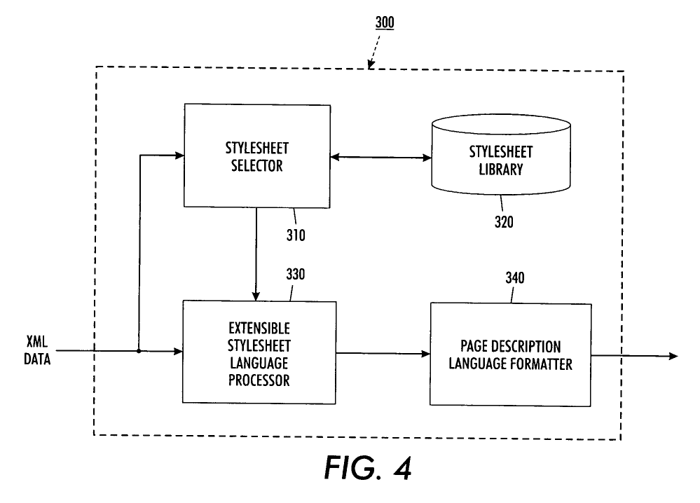

FIG. 4 illustrates a block diagram an example of an extensible markup language processor 300. As illustrated in FIG. 4, extensible markup language data is received by an extensible stylesheet language processor 330 and an extensible stylesheet language transform selector 310. The extensible stylesheet language transform selector 310 utilizes the extensible markup language data to select the proper extensible stylesheet language transform from an extensible stylesheet language transform library 320. The selected extensible stylesheet language transform is fed to the extensible stylesheet language processor 330.

The extensible stylesheet language processor 330 processes the received extensible markup language data and selected extensible stylesheet language transform to produce an extensible stylesheet language formatting object tree, a tree whose nodes are extensible stylesheet language formatting objects. The extensible stylesheet language formatting object tree is received by a page description language formatter 340. The page description language formatter 340 converts the extensible stylesheet language formatting object tree into a language that can be readily rendered by the digital printing device. For example, the page description language formatter 340 may convert the extensible stylesheet language formatting object tree into a portable document format object.

The converted extensible stylesheet language formatting object tree is sent onto the controller for further processing in preparation for reproduction by the print engine.

As noted above, the extensible markup language data is received by extensible stylesheet language processor 330 and the extensible stylesheet language transform selector 310. The extensible stylesheet language processor 330, through the extensible stylesheet language transform selector 310, accesses the appropriate extensible stylesheet language transform (and, optionally, the extensible stylesheet language schema) and processes the extensible markup language data according to the mapping contained in the extensible stylesheet language transform (optionally using type definitions provided in the extensible stylesheet language schema). The result of this processing is a transformation of the extensible markup language to extensible stylesheet language formatting object tree, a tree whose nodes are extensible stylesheet language formatting objects.

Thereafter, the page description language formatter 340 converts the extensible stylesheet language formatting object format into a format which can then be printed.

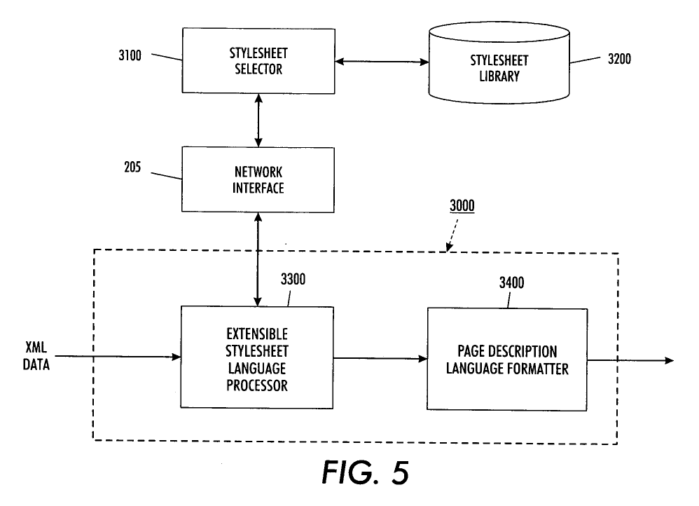

In another example, as illustrated in FIG. 5 , extensible markup language data is received by an extensible markup language processor 3000 which includes an extensible stylesheet language processor 3300. The extensible stylesheet language processor 3300 analyzes the received extensible markup language data and sends a request signal, through a network interface 205, to an extensible stylesheet language transform selector 3100. The extensible stylesheet language transform selector 3100 utilizes the request signal to select the proper extensible stylesheet language transform from an extensible stylesheet language transform library 3200. This extensible stylesheet language transform library 3200 may be located on a server or other remote storage device. The selected extensible stylesheet language transform is fed back to the extensible stylesheet language processor 3300, through the network interface 205.

The extensible stylesheet language processor 3300 processes the received extensible markup language data and selected extensible stylesheet language transform to produce an extensible stylesheet language formatting object tree. The extensible stylesheet language formatting object tree is received by a page description language formatter 3400. The page description language formatter 3400 converts the extensible stylesheet language formatting object tree into a language that can be readily rendered by the digital printing device. For example, the page description language formatter 3400 may convert the extensible stylesheet language formatting object tree into a portable document format object.

The converted extensible stylesheet language formatting object is sent onto the controller for further processing in preparation for reproduction by the print engine.

It is noted that if the extensible stylesheet language transforms are stored directly in the digital printing device, as illustrated in FIG. 4, the library of extensible stylesheet language transforms can be readily updated. For example, the extensible stylesheet language transform library 320 can be updated by directly transmitting the extensible stylesheet language transforms to the digital printing device via the network interface 205. The controller 206 distinguishes an extensible stylesheet language transform from a print document and loads the extensible stylesheet language transform into the extensible stylesheet language transform library 320.

Another way of updating the extensible stylesheet language transform library 320 is to instruct the digital printing device to retrieve and load extensible stylesheet language transforms from a remote network linked location. The instructions cause the controller 206 to retrieves the extensible stylesheet language transforms from the location specified in the instructions by sending out a request via the network interface 205. The remote location on the network sends back the extensible stylesheet language transforms via the network interface 205. The controller 206 loads the extensible stylesheet language transforms into the extensible stylesheet language transform library 320.

In view of the foregoing examples, a digital printing device is embedded with the possessing capability to perform print instructions based on the translation of a mapping of metadata elements found within input data with print instructions. The possessing capabilities may be realized by a dedicated hardware circuit, software, or a combination thereof.

As noted above, the extensible stylesheet language transforms (and, optionally, extensible markup language schemas) may be loaded into a memory of the digital printing device to provide an initial set of mappings. The particular extensible stylesheet language transforms (and optional extensible markup language schemas) chosen for loading may allow the digital printing device to be customized for a particular user, enhancing the value of the digital printing device to that user. Depending on the need of the user, the extensible stylesheet language transforms (and optional extensible markup language schemas) can be locked down.

It is noted that the digital printing device may achieve maximum flexibility by retrieving extensible stylesheet language transforms (and, optionally, extensible markup language schemas) from the network in combination with extensible stylesheet language transforms (and, optionally, extensible markup language schemas) stored in the digital printing device's memory. In this way special extensible stylesheet language transforms (and, optionally, extensible markup language schemas) may be chosen to be overridden by stored extensible stylesheet language transforms (and, optionally, extensible markup language schemas) while other extensible stylesheet language transforms (and, optionally, extensible markup language schemas), not stored in the memory, are retrieved from the network.

This would allow a user to automatically utilize a customized version of a standard extensible stylesheet language transform (and, optionally, an extensible markup language schema) while defaulting to the network for others. Conversely, the digital printing device may be set to prefer extensible stylesheet language transforms (and, optionally, extensible markup language schemas) from the network, only utilizing specific extensible stylesheet language transforms (and, optionally, extensible markup language schemas) from memory where no such specific extensible stylesheet language transforms (and, optionally, extensible markup language schemas) exist on the network.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A digital printing device, comprising:
a housing:
said housing including,
a print engine to reproduce an image on a recording medium,
a controller to control operations of said print engine,
an extensible markup language processor to receive extensible markup language data and extensible stylesheet language data,
said extensible markup language processor converting the received extensible markup language data, using the received extensible stylesheet language data, to an extensible stylesheet language formatting object tree, and
a page description language formatter to convert the extensible stylesheet language formatting object tree into a page description language;
said controller controlling said print engine to reproduce an image on a recording medium, corresponding to the received extensible markup language data, in accordance with the generated page description language.

2. The digital printing device as claimed in claim 1, further comprising:
an extensible stylesheet language data library to store a plurality of selectable extensible stylesheet language transforms and extensible stylesheet language schemas.

3. The digital printing device as claimed in claim 2, wherein said extensible stylesheet language data library is modifiable.

4. A digital printing system, comprising:
a network;
a digital printing device operatively connected to said network; and
an extensible stylesheet language data library, operatively connected to said network, to store selectable extensible stylesheet language data;
said digital printing device including,
a controller to control operations of said print engine,
an extensible markup language processor, and
a page description language formatter;
said extensible markup language processor receiving extensible markup language data and generating a request signal for said extensible stylesheet language data library, in response to the received extensible markup language data;
said extensible stylesheet language data library retrieving appropriate extensible stylesheet language data based upon the request signal;
said extensible markup language processor converting the received extensible markup language data, using said extensible stylesheet language data, to an extensible stylesheet language formatting object tree, and
said page description language formatter converting the extensible stylesheet language formatting object tree into a page description language;
said controller controlling said print engine to reproduce an image on a recording medium, corresponding to the received extensible markup language data, in accordance with the generated page description language.

5. The digital printing system as claimed in claim 4, wherein said extensible stylesheet language data library stores a plurality of selectable extensible stylesheet language transforms and, optionally, extensible stylesheet language schemas.

6. A method of printing extensible markup language data received by a digital printing device, comprising:
(a) receiving, by the digital printing device, extensible markup language data;
(b) retrieving appropriate extensible stylesheet language data based upon the received extensible markup language data;
(c) converting the received extensible markup language data, using the extensible stylesheet language data, to an extensible stylesheet language formatting object tree;
(d) converting the extensible stylesheet language formatting object tree into a page description language; and
(e) reproducing an image on a recording medium, corresponding to the received extensible markup language data, in accordance with the generated page description language.

7. The method as claimed in claim 6, wherein the appropriate extensible stylesheet language data is retrieved, over a network, from a remote memory device.

8. The method as claimed in claim 6, wherein the appropriate extensible stylesheet language data is an extensible stylesheet language transform, optionally supplemented with an extensible stylesheet language schema.
